(19) United States
(12) Patent Application Publication
(10) Pub. No.: US 2018/0017192 A1
(43) Pub. Date: Jan. 18, 2018

(54) DEVICE AND METHOD FOR COUPLING PIPES

(71) Applicant: Bradford G. BARUH, Hillsborough, CA (US)

(72) Inventor: Bradford G. BARUH, Hillsborough, CA (US)

(21) Appl. No.: 15/512,717

(22) PCT Filed: Sep. 21, 2015
(86) PCT No.: PCT/US2015/051129

§ 371 Date: Mar. 20, 2017

Related U.S. Application Data
(60) Provisional application No. 62/052,650, filed on Sep. 19, 2014.

(51) Int. Cl. F16L 13/10; F16L 41/02; F16L 55/16

(52) U.S. Cl. CPC F16L 13/103; F16L 41/021; F16L 2201/60; F16L 55/1608

(57) ABSTRACT

A pipe coupling and a method of use are disclosed. The pipe coupling including an elongated housing including a first end and a second end, a stop located on an inner diameter of the housing, the stop located between the first end and the second ends of the housing, wherein a distance from the stop to one of the first and second ends is at least two times a distance from the stop to the other of the first and second end of the housing, and at least one marking on an outer surface of the housing adjacent to the first end of the elongated housing, the at least one marking extending towards the second end for a predetermined length.

### CROSS-REFERENCE TO RELATED APPLICATIONS

This application claims the benefit of U.S. Provisional Application No. 62/052,650, filed Sep. 19, 2014, the entire contents of which is hereby incorporated herein by reference.

### FIELD OF THE DISCLOSURE

This disclosure relates to a device and method for coupling pipe ends.

### BACKGROUND OF THE DISCLOSURE

Sprinkler systems using plastic or PVC (polyvinyl chloride) pipes have become widely used as a result of their low cost and ease of connection and repair. Such pipes may be joined without threading by applying an adhesive such as a solvent cement to the ends of the pipes and the coupling then slipping the coupling over the ends.

However, installing new pipe and repairing sprinkler systems and broken pipe has traditionally been a difficult and complicated procedure. When a break occurs in an underground sprinkler system, the repair process has required isolating the break and then excavating around or otherwise clearing a long section of the PVC pipe surrounding the break. As disclosed in Zimmerman, U.S. Pat. No. 4,687,232, a long section of pipe on both sides of the break is required because the standard repair or new construction coupling until now has comprised a short piece of similar PVC piping which is radially enlarged relative to the pipe to be repaired and which is slipped and solvent welded over the broken ends of pipe. This requires that the broken ends of pipe be relatively free in order to have enough play to be bent back so that the weld coupling may be inserted and then the broken ends of pipe moved toward each other into the coupling. This method of bending and moving the pipe sections to be joined frequently results in an insertion of extra pipe length into the existing pipe line exerting additional stresses upon the pipe line. This problem is exacerbated in the instance of PVC pipe having a large diameter since in order to gain the required flexibility, a much greater length of pipe must be cleared on either side of the break. The same difficulties pertain wherein an additional branch pipe is to be added to an existing line since the existing pipe must be cut and a T-coupling inserted in the manner described above.

In repairing non-PVC pipe, the process is much more complicated. Frequently the entire length of pipe that is broken must be removed and a new length of pipe, if it is compatible, must be replaced and sometimes forced into place to fit the existing couplings. Otherwise, a torch cutting procedure must be employed and then a new length of pipe must be fitted and welded or otherwise heat fused into place.

In addition, the use of pipe couplings is not limited to the repair of sprinkler systems and other broken pipes. Pipe couplings are also in demand for new construction projects.

In repairing old sprinklers or completion of new construction, various devices have been developed and used. One solution has been the use of an extendable housing, which can be expensive. Alternatively, when repairing or completing a section of pipe, if a gap is left for removing a section of broken pipe or inaccurate measurements in new construction, using traditional pipe couplings, at least two pipe couplings and a length of pipe are needed to repair or complete the section of pipe. The present disclosure can repair or complete most of these sections with a single pipe coupling.

Accordingly, what is needed is a low cost, easy to use and effective means of coupling pipe ends for use with sprinkler systems, conduits in walls or fixed pipes in substrates, and other coupling of pipe ends.

It would be highly desirable to provide an easy to use and cost-effective way to repair or connect pipe ends.

### SUMMARY OF THE DISCLOSURE

This disclosure provides a simple, low-cost way for new construction, repairing or completing the assembly of pipe ends.

In accordance with an exemplary embodiment, a pipe coupling comprises: an elongated housing comprising a first end and a second end, the housing defining an elongated bore therein; a stop located on an inner diameter of the housing, the stop located between the first end and the second ends of the housing, wherein a distance from the stop to one of the first and second ends is at least two times a distance from the stop to the other of the first and second end of the housing; a first cylindrical bore extending from the first end to the stop; a second cylindrical bore extending from the second end to the stop, wherein a length of the first cylindrical bore is greater than the second cylindrical bore; and at least one marking on an outer surface of the housing adjacent to the first end of the elongated housing, the at least one marking extending towards the second end for a predetermined length.

In accordance with an exemplary embodiment, a method of installing a pipe coupling comprises: selecting a pipe coupling comprising: an elongated housing comprising a first end and a second end, the housing defining an elongated bore therein; a stop located on an inner diameter of the housing, the stop located between the first end and the second ends of the housing, wherein a distance from the stop to one of the first and second ends is at least two times a distance from the stop to the other of the first and second end of the housing; a first cylindrical bore extending from the first end to the stop; a second cylindrical bore extending from the second end to the stop, wherein a length of the first cylindrical bore is greater than the second cylindrical bore; and at least one marking on an outer surface of the housing adjacent to the first end of the elongated housing, the at least one marking extending towards the second end for a predetermined length; inserting the first cylindrical bore of the pipe coupling onto a first pipe end; advancing the pipe coupling in a first direction onto the first pipe end; aligning the second cylindrical bore of the piping coupling with a second pipe end; and advancing the pipe coupling in an opposite direction onto the second pipe end until the stop reaches the second pipe end.

### BRIEF DESCRIPTION OF THE DRAWINGS

The disclosure will now be described in greater detail with reference to the exemplary embodiments illustrated in the accompanying drawings, in which like elements bear like reference numerals, and wherein:

FIG. 1 is a perspective view of a pipe coupling according to an exemplary embodiment of the present disclosure.

FIGS. 2A-2C are perspective views of the pipe coupling of FIG. 1 in use in accordance with an exemplary embodiment.

FIG. 3A is a side view of a pipe coupling according to an exemplary embodiment of the present disclosure.

FIG. 3B is a side view of a pipe coupling according to an exemplary embodiment of the present disclosure.

FIG. 3C is an end view of the pipe coupling of FIG. 3B in accordance with an exemplary embodiment.

FIG. 3D is an end view of a portion of the pipe coupling of FIG. 3B in accordance with an exemplary embodiment.

FIG. 4A is a perspective view a pipe coupling according to an exemplary embodiment of the present disclosure.

FIG. 4B is a top view of the pipe coupling of FIG. 4A in accordance with an exemplary embodiment.

FIG. 5 is a cross-sectional view of a pipe coupling in accordance with an exemplary embodiment.

FIGS. 6A and 6B are end view of the pipe coupling of FIG. 5 in accordance with an exemplary embodiment.

FIGS. 7A-7C are perspective views of the pipe coupling of FIGS. 3A-3D and 4A-4B in use in accordance with an exemplary embodiment.

FIGS. 8A-8C are cross-sectional views of a pipe coupling having one or more breakaway stops in accordance with an exemplary embodiment.

FIGS. 9A-9C are cross-sectional view of a copper pipe coupling in accordance with an exemplary embodiment.

### DETAILED DESCRIPTION OF THE EXEMPLARY EMBODIMENTS

The device and method according to the present disclosure provide a low cost and easy-to-use pipe coupling that can avoid the difficulties associated with standard pipe couplings.

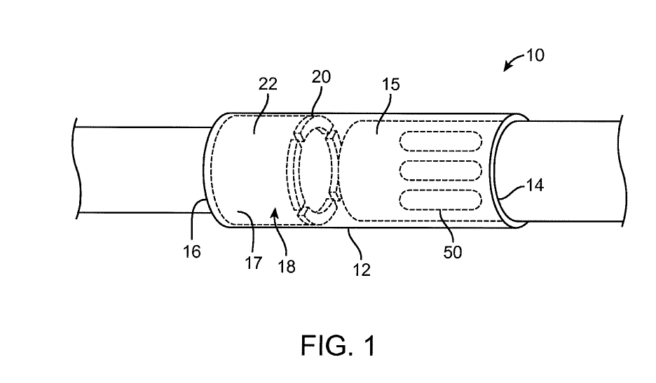

The disclosure can be best understood by reference to FIG. 1, which illustrates a basic form of the pipe coupling 10. The pipe coupling 10 includes an elongated housing 12 having a first end 14 and a second end 16, the housing 12 defining an elongated cylindrical bore 18 therein. A stop 20 is located on an inner diameter 22 of the housing 12, and between the first end 14 and the second end 16 of the housing 12. A distance from the stop 20 to the first end 14 of the housing 12 is greater than a distance from the stop 20 to the second end 16.

The elongated housing 12 preferably has a circular outer diameter. In accordance with an exemplary embodiment, the outer diameter of the housing 12 may be square or any other shape. In accordance with an exemplary embodiment, the outer housing 12 has a series of markings (or ribs) 50, which extend around an outer perimeter of the housing 12 on the end opposite of the stop 20. For example, as shown in FIG. 1, the markings 50 can be a series of rectangular shapes ribs, which extend length wise on the housing 12 with rounded edges. In accordance with an exemplary embodiment, the markings or ribs 50 can be any shape and/or size, however, it is preferable that the markings 50 preferably have a predetermined length, for example, one inch, which can help the user measure a distance or length for the cut in the existing pipe to be repaired and can also provide a guide for which end of the coupling 10 is placed first on a pipe end. In addition, the outer markings 50 can act marking to identify the pipe coupling 10 in a bin of couplings as having a stop 20 as disclosed herein. For example, in accordance with an exemplary embodiment, the markings can be about 1 inch in length and having a height not exceeding, for example, about 0.1 inches, and more preferably, about 0.02 to 0.08 inches.

In accordance with an exemplary embodiment, the stop 20 can be located on the inner diameter 22 of the elongated housing 12. The stop 20 can be a circular ring, at least two rectangular inserts, a portion of a circular ring or any other shape, which can help prevent the pipe coupling 10 from advancing beyond a certain point.

The stop 20 further divides the elongated cylindrical bore 18 into a first cylindrical bore 15 located between the stop 20 and the first end 14 and a second cylindrical bore 17 located between the stop 20 and the second end 16. The first and second cylindrical bores 15, 17 can be configured to allow a pipe to advance into the pipe coupling 10 until reaching the stop 20.

In addition, the stop 20 provides a means for insuring that the pipe ends have sufficient overlap between an outer surface of the pipe ends and the inner diameter 22 of the housing 12 for a proper seal to be formed. The stop 20 also ensures that a sufficient amount of an adhesive will be present to bond the outer diameter of the pipe end to the inner diameter 22 of the pipe coupling 10.

In accordance with an exemplary embodiment, the distance from the stop 20 to the first end 14 is between about two to ten times the distance from the stop 20 to the second end 16. In an exemplary embodiment, the distance from the stop 20 to the first end 14 is at least two times the distance from the stop 20 to the second end 16. However, the distance can vary depending on the particular use of the pipe coupling 10.

The housing 12 of the pipe coupling 10 can have an elongated cylindrical bore 18 therein which provides a conduit or fluid flow channel. The elongated cylindrical bore 18 includes the stop 20, which divides the elongated cylindrical bore 18 into the first cylindrical bore 15 and the second cylindrical bore 17.

In accordance with an exemplary embodiment, the pipe coupling 10 of FIG. 1 for use with a ¾ inch pipe, the housing 12 is approximately 2.5 inches from the first end 14 to the second end 16. The cylindrical bore 18 therein in, for example, can have a diameter of about 0.70 inches to about 0.90 inches, for example, 0.74 to 0.82 inches in diameter. The housing 12 can have, for example, an outer diameter of about 1.00 to 1.10 inches, for example, about 1.050 inches. The first cylindrical bore 15 extends approximately 1.75 inches from the first end 14 to the stop 20. The stop 20 extends approximately 0.125 inches into the cylindrical bore 18. The second cylindrical bore 19 extends approximately 0.75 inches from the stop 20 to the second end 16 of the housing 12.

The first end 14 and the second end 16 of the pipe coupling 10 are generally flat, however, it can be appreciated that in an alternative embodiment of the present disclosure, the first and second ends 14, 16 are beveled (not shown) on the inner diameter 22 of the first and second cylindrical bores 15, 17, which can provide a smooth and easy transition for the pipe coupling 10 to slide onto a pipe end.

The pipe coupling 10 is preferably molded of PVC (polyvinyl chloride). However, the pipe coupling 10 may be made by other known methods and can be made of any type of plastic, copper, rubber, steel or any other material suitable for sprinkler systems, electrical conduit, sewer pipes, or any other situation where two pipe ends are coupled.

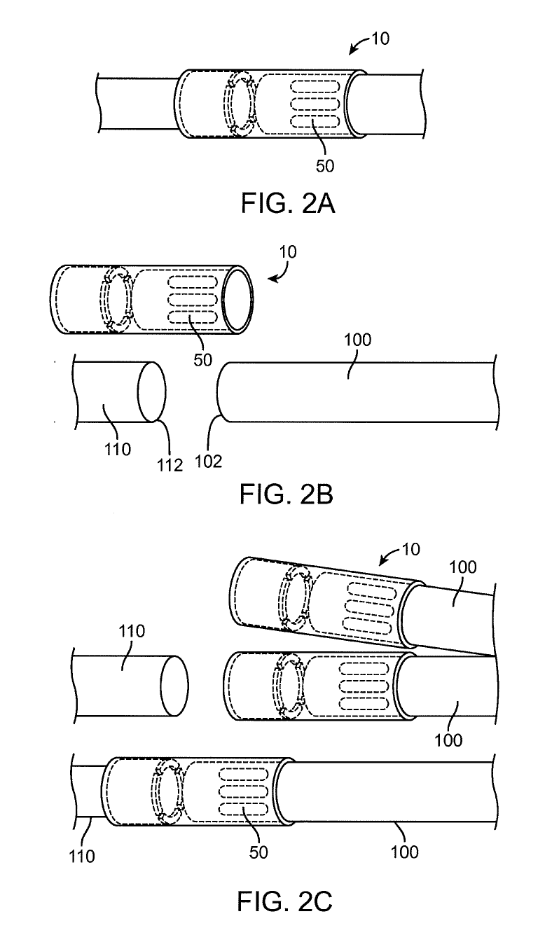

FIGS. 2A-2C are perspective views of the pipe coupling of FIG. 1 in use in accordance with an exemplary embodiment. Traditionally, when a break occurs in a PVC sprinkler system, it can be repaired by digging away the dirt over the break, cutting a small section of pipe containing the break, and connecting a new section of pipe in place using a pipe coupling having a circular ring, which is positioned at an equal distance from each end of the coupling. The coupling can be installed by bending one or both of the pipes in the ground, so that the gap between the pipes is sufficient to insert the pipe coupling onto the ends of the two pipe ends. Once the coupling is inserted onto the pipe ends, the pipes are released and returned to their original positions. However, this type of repair can be very difficult and presents several problems including having to remove the dirt around the pipes to permit sufficient bending of the pipes and if too much of the pipe is cut away the pipe coupling may not be able to connect the two pipe ends regarding addition of a replacement pipe segment and two couplings. In addition, in some circumstances, there may not be sufficient room to make such a repair.

In accordance with an exemplary embodiment, the pipe coupling 10 of the present disclosure can be used for repairing a sprinkler system as illustrated in FIGS. 2A-2C. First, for example, the dirt around the break is removed and a small section of the pipe containing the break is removed, as shown in FIG. 2B. However, with the pipe coupling 10 of the present disclosure, a larger section of the pipe containing the break may be removed without creating any difficulties. Once the section of pipe is removed, the longer end 14 of the pipe coupling 10 of the present disclosure is placed on one of the pipe ends 102, 112.

In accordance with an exemplary embodiment, the pipe coupling 10 has the markings (or ribs) 50 on the longer end, such that the installer or user can ascertain which end of the pipe coupling 10 should be used first. The first end 14 of the pipe coupling 10 is inserted onto a pipe end 102 of a first pipe 100. The pipe coupling 10 is advanced onto the pipe end 102 until the second end 16 of the pipe coupling 10 clears the pipe end 112 of the second pipe 110. In some situations, with the advancing or sliding of the pipe coupling 10 onto the pipe end the user will hear a “click” as the pipe end reaches the stop 20.

The second end 16 of the pipe coupling 10 is then aligned with the pipe end 112 of the second pipe 110. The pipe coupling 10 is then advanced in an opposite direction onto the second pipe 110 until the stop 20 reaches the pipe end 112 of the second pipe 110, as shown in FIG. 2B. Once again, a “click” may be heard indicating that the pipe coupling 10 has reached the end of the second pipe. The stop 20 helps ensure that sufficient coverage or overlapping of the pipe coupling 10 and the pipe ends are achieved. In most situations, an adhesive will be applied to the inner diameter 22 of the first end 14 and second end 16 of the pipe coupling 10 before the pipe coupling 10 is inserted onto the pipe ends. The adhesive can provide a water or air tight seal between the pipe coupling 10 and the pipe ends 102, 112.

As shown in FIGS. 2A-2C, the repair can be performed using a single coupling 10 according to the present disclosure. However, if a traditional coupling were used, a length of pipe would have to be inserted between the two pipe couplings to complete the repair. For example, if the sprinkler pipe is a ¾ inch diameter pipe and a 2 inch section of pipe is removed, it would be desirable to repair the sprinkler system with a pipe of at least 3.5 inches in length. A 3.5 inch pipe coupling is long enough to replace the 2 inch section of pipe removed from the pipe and allow for at least ¾ of an inch overlap on each of the pipe ends. In accordance with an exemplary embodiment, the pipe coupling can be designed to provide between 2 to 5 times a diameter of the pipe overlap on each end of the pipe. Thus, the present disclosure reduces the number of pipe couplings needed for most repair jobs.

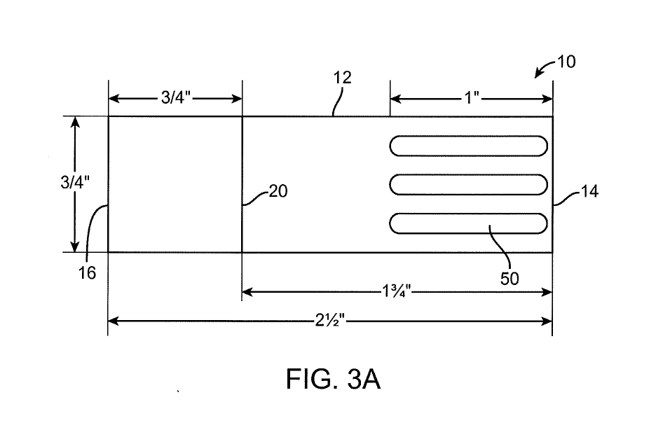

FIG. 3A is a side view of a pipe coupling 10 according to an exemplary embodiment of the present disclosure. As shown in FIG. 3A, the pipe coupling 10 can have an overall length of about 2.5 inches, an outer diameter of about 0.75 inches. In accordance with an exemplary embodiment, the distance from the stop 20 to the first and second ends 14, 16 is about 1.75 inches and 0.75 inches, respectively. The distances as shown in FIG. 3A are estimates, and can vary, for example, by plus or minus about 10% to accommodate for thickness of, for example, the outer housing 12 of the coupling and the stop 20.

FIG. 3B is a side view of a pipe coupling 10 according to an exemplary embodiment of the present disclosure. As shown in FIG. 3B, the pipe coupling 10 can have an overall length of about 2.5 inches, an outer diameter of about 1.075 to 1.080 inches, and an inner diameter of about 0.875 inches. In accordance with an exemplary embodiment, the distance from the stop 20 to the first and second ends 14, 16 is about 1.75 inches and 0.75 inches, respectively. In accordance with an exemplary embodiment, the markings 50 can have a length of about 1 inch and a height of about 0.02 inches (FIGS. 3C and 3D).

FIG. 3C is an end view of the pipe coupling 10 of FIG. 3B in accordance with an exemplary embodiment. As shown in FIG. 3C, the markings 50 are positioned on the outer housing 12. In accordance, with an exemplary embodiment, the markings 50 can be between 4 and 12, and more preferably 8, which are positioned around the outer circumference of the coupling 10 at equal distances.

FIG. 3D is an end view of a portion of the pipe coupling 10 of FIG. 3B in accordance with an exemplary embodiment. As shown in FIG. 3D, the markings 50 can have, for example, a height of about 0.02 inches, a width on the outer housing 12 of about 0.09 inches, an outer or top width of about 0.03 inches, and a height of about 0.02 inches.

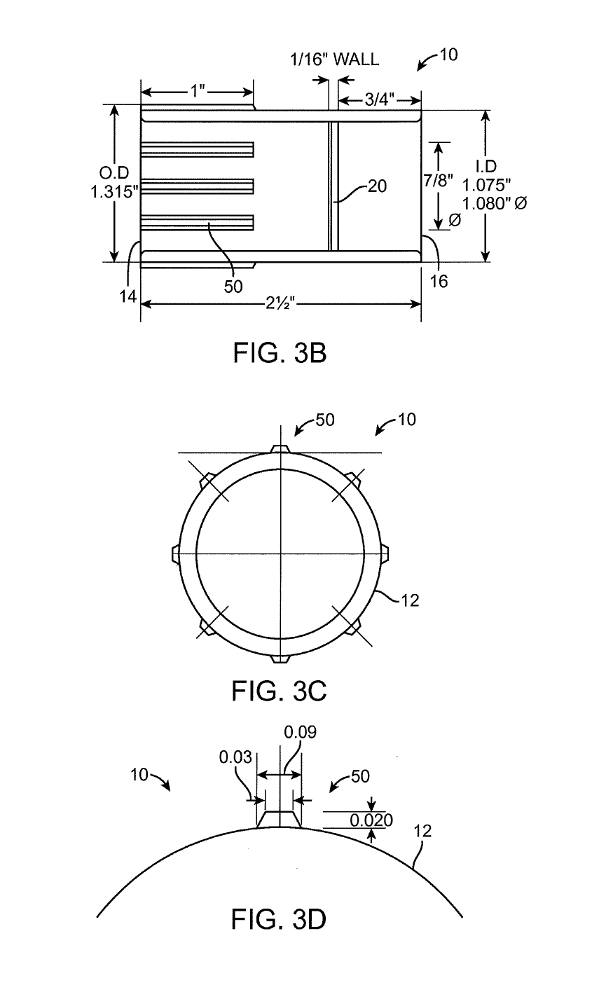

As illustrated in FIG. 4A, in an alternative embodiment, the housing 12 of the pipe coupling 10 forms a “T” joint for the connection of three pipes. Here, a third end 34 is at an approximate 90-degree angle or perpendicular to the first end 14 and the second end 16 forming a third cylindrical bore 32. A stop 20 is located in the elongated cylindrical bore 18 forming a first cylindrical bore 15 and a second cylindrical bore 17. In accordance with an exemplary embodiment, the third end 34 can accommodate all standard fittings including nipples, inserts, additional piping, 45° angle inserts, 90° angle inserts, or adapters for special fittings.

In normal use, an adhesive will be applied to the inner diameter 22 of the first end 14 and the second end 16 of the pipe coupling 10 before inserting the pipe end into the pipe coupling. Any commercially available adhesive should work with the pipe coupling. The adhesives generally are sold with drying time of between 5 seconds and 5 minutes, which provides sufficient time to insert the pipe coupling 10 onto the end of the first pipe end, advance it to the stop 20, align the second pipe end, and advance the pipe coupling 10 onto the second pipe end.

FIG. 4B is a top view of the pipe coupling of FIG. 4B in accordance with an exemplary embodiment. As illustrated in FIG. 4B, the housing 12 of the pipe coupling 30 forms a “T” joint for the connection of three pipes. Here, a third end 34 is at an approximate 90-degree angle or perpendicular to the first end 14 and the second end 16 forming a third cylindrical bore 32. A stop 20 can be located in the elongated cylindrical bore 18 forming a first cylindrical bore 15 and a second cylindrical bore 17. In accordance with an exemplary embodiment, the third end 34 can accommodate all standard fittings including nipples, inserts, additional piping, 45° angle inserts, 90° angle inserts, or adapters for special fittings.

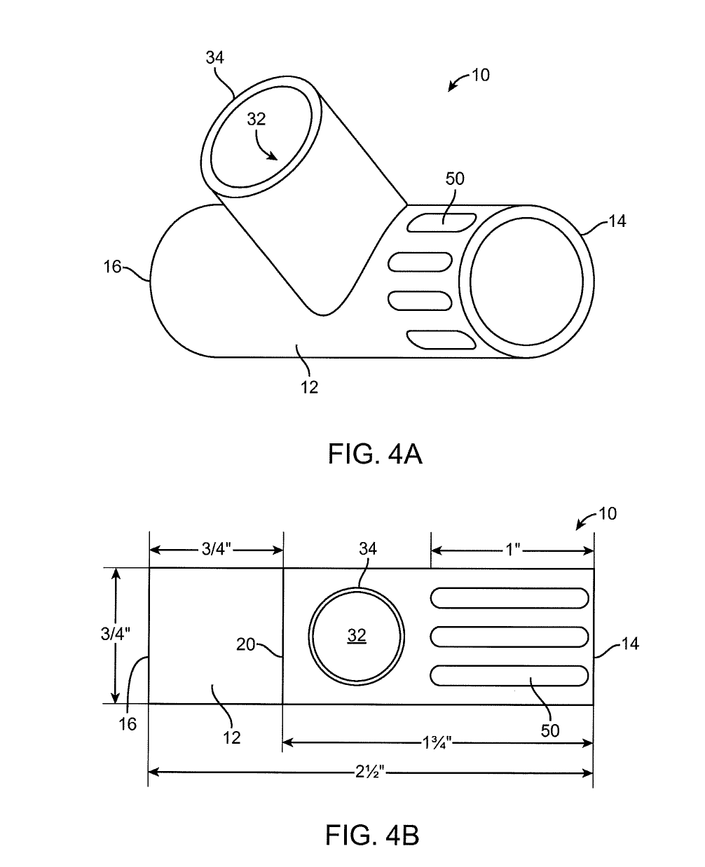

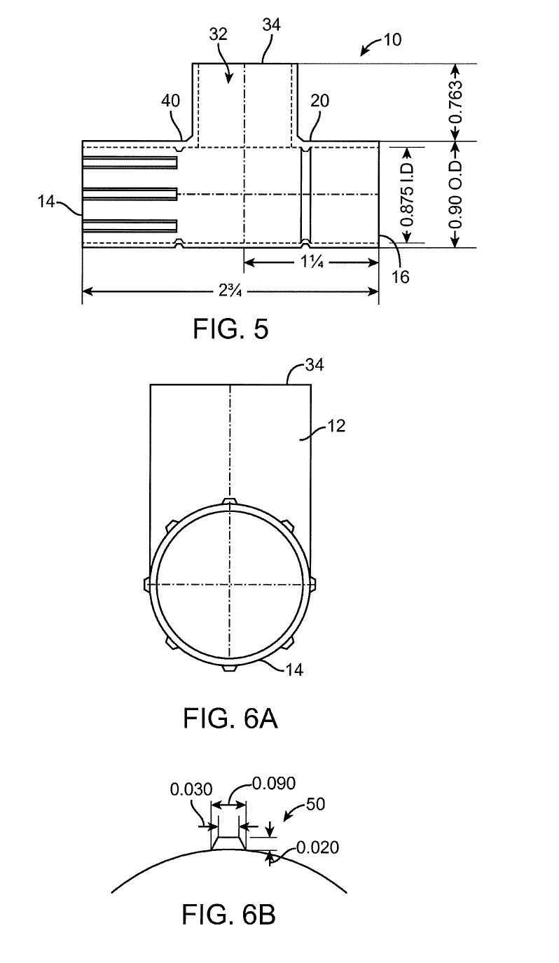

FIG. 5 is a cross-sectional view of a pipe coupling, for example, made of copper, in accordance with an exemplary embodiment. FIGS. 6A and 6B are end views of the pipe coupling of FIG. 5 showing the markings (or ribs) 50 on the outer housing. As shown in FIGS. 5 and 6, the housing 12 of the pipe coupling 30 forms a “T” joint for the connection of three pipes. Here, a third end 34 is at an approximate 90-degree angle or perpendicular to the first end 14 and the second end 16 forming a third cylindrical bore 32. A stop 20 is located in the elongated cylindrical bore 18 forming a first cylindrical bore 15 and a second cylindrical bore 17.

In accordance with an exemplary embodiment, one or more small passable stops (or indentations) 40 can be place within the first cylindrical bore 15, which can be used for copper pipes and the like for new installation to provide a signal or warning to an installer that an appropriate overlap has been reached between the pipe end 102, 112, and the first cylindrical bore 15. Alternatively, for repairs, the pipe end 102, 112 can be pushed through the one or more passable stops or indentations 40 as disclosed above.

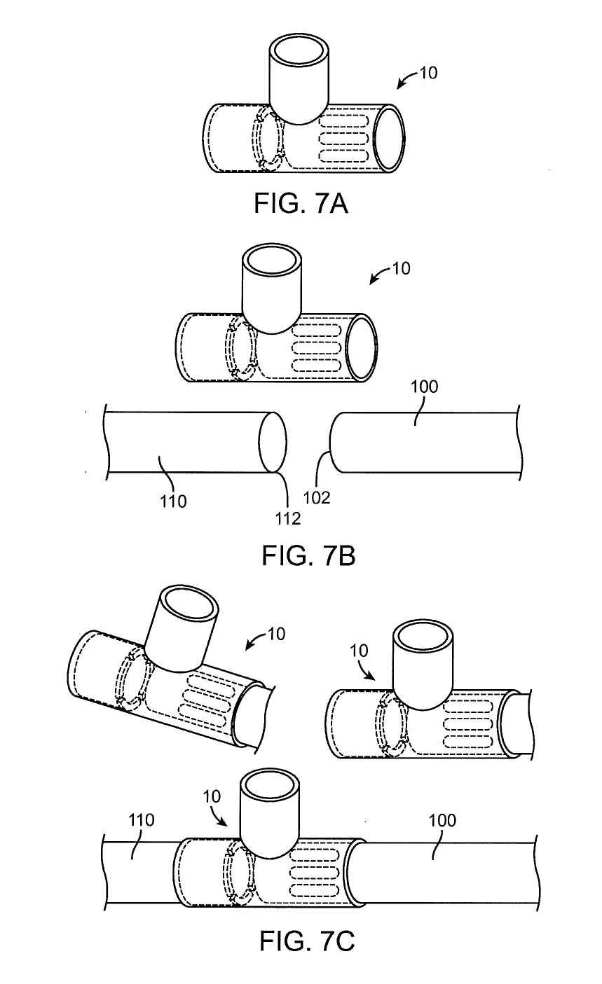

FIGS. 7A-7C are perspective views of the pipe coupling of FIGS. 3A-6B in use in accordance with an exemplary embodiment. In accordance with an exemplary embodiment, the pipe coupling 10 of the present disclosure can be used for repairing a sprinkler system as illustrated in FIGS. 7A-7C. First, for example, the dirt around the break is removed and a small section of the pipe containing the break is removed, as shown in FIG. 7B. However, with the pipe coupling 10 of the present disclosure, a larger section of the pipe containing the break may be removed without creating any difficulties. Once the section of pipe is removed, the longer end 14 of the pipe coupling 10 of the present disclosure is placed on one of the pipe ends 102, 112.

In accordance with an exemplary embodiment, the pipe coupling 10 has the markings 50 on the longer end, such that the installer or user can ascertain which end of the pipe coupling 10 should be used first. The first end 14 of the pipe coupling 10 is inserted onto a pipe end 102 of a first pipe 100. The pipe coupling 10 is advanced onto the pipe end 102 until the second end 16 of the pipe coupling 10 clears the pipe end 112 of the second pipe 110. In some situations, with the advancing or sliding of the pipe coupling 10 onto the pipe end the user will hear a “click” as the pipe end reaches the stop 20.

The second end 16 of the pipe coupling 10 is then aligned with the pipe end 112 of the second pipe 110. The pipe coupling 10 is then advanced in an opposite direction onto the second pipe 110 until the stop 20 reaches the pipe end 112 of the second pipe 110, as shown in FIG. 7B. Once again, a “click” may be heard indicating that the pipe coupling 10 has reached the end of the second pipe. The stop 20 helps ensure that sufficient coverage or overlapping of the pipe coupling 10 and the pipe ends are achieved. In most situations, an adhesive will be applied to the inner diameter 22 of the first end 14 and second end 16 of the pipe coupling 10 before the pipe coupling 10 is inserted onto the pipe ends. The adhesive can provide a water or air tight seal between the pipe coupling 10 and the pipe ends 102, 112.

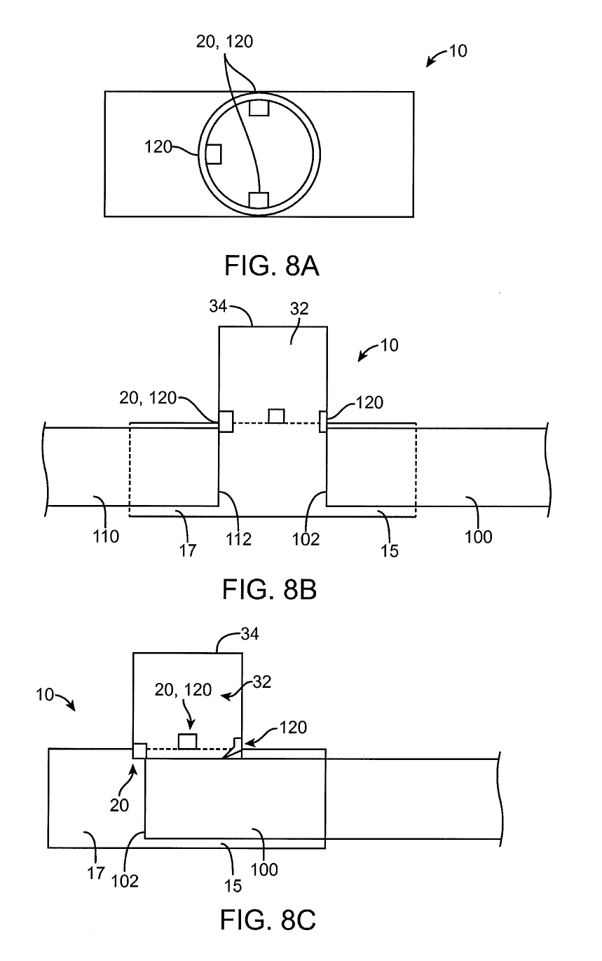

FIGS. 8A-8C are cross-sectional views of a pipe coupling 10 having one or more breakaway stops in accordance with an exemplary embodiment. In accordance with an exemplary embodiment, the pipe coupling 10 can include a fixed stop 20, and one or more breakaway (or passage) stops 120. As shown in FIGS. 8A-8C, the pipe coupling 10 can include a third end 34, which is at an approximate 90-degree angle or perpendicular to the first end 14 and the second end 16 forming a third cylindrical bore 32. A fixed stop 20 is located in the elongated cylindrical bore 18 forming a first cylindrical bore 15 and a second cylindrical bore 17.

In accordance with an exemplary embodiment, one or more breakaway (or passage) stops 120 can be positioned in the first and/or third cylindrical bores 15, 32, preferably adjacent to the intersection of the first and third cylindrical bores 15, 32, such that a warning can be provided to an installer in a new installation, for example, that the pipe end has reached the transition from one of the cylindrical bore 15, 32 into the other cylindrical bore 15, 32, such that a pipe end 102, 112 does not block or obstruct the flow within the coupling 10. The breakaway stops 120 can be on or more stops having any suitable shape and upon a desired force contacting the stops 120 in the form of a pipe end, they easily break such the installer can feel that the pipe end has reached a transition from one cylindrical bore 15, 37 to another cylindrical bore 15, 37.

In accordance with an exemplary embodiment, as shown in FIGS. 8A-8C, the coupling 10 can include two fixed stops 20, and one breakable stop 120, or alternatively, one fixed stop 20, and two breakable stops 120. For example, the stop 20, 120 within the third cylindrical bore 32 can be a fixed stop 20, or a breakable stop 120.

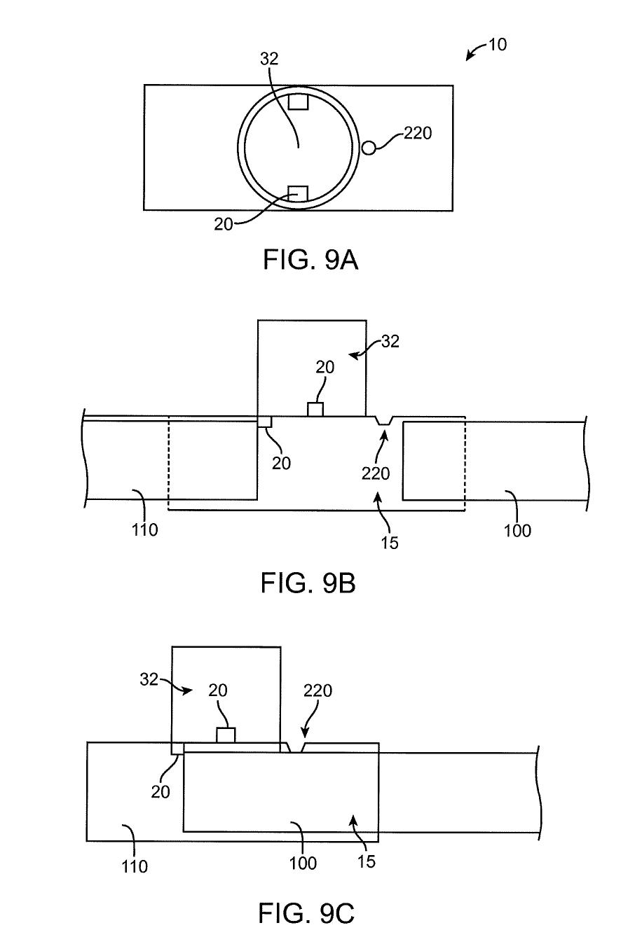

FIGS. 9A-9C are cross-sectional view of a copper pipe coupling in accordance with an exemplary embodiment. As shown in FIGS. 9A-9C, rather than a breakaway or a passable stop as shown in FIGS. 8A-8C, the copper coupling 10 can include one or more passable indentations 220. In accordance with an exemplary embodiment, the one or more passage indentations 220 can be configured to having any suitable shape and upon a desired force contacting the stops 120 in the form of a pipe end, they easily deform such the installer can feel that the pipe end has reached a transition from one cylindrical bore 15, 32 to another cylindrical bore 15, 32, however, if desired, the pipe end, for example, a copper pipe end, can slide past the passable indentation 220.

In accordance with an exemplary embodiment, the pipe coupling 10 will preferably be manufactured in conventional U.S. measurements or metric lengths depending on the country of use. However, in order to accommodate the various lengths that a consumer may need, the pipe coupling 10 can be manufactured and/or cut to a desired length, for example, using a saw or a string saw.

In an exemplary embodiment, the pipe coupling 10 has a length of between about 3½ inches and about 5½ inches. In accordance with an exemplary embodiment, the length of the pipe coupling may vary in length. In addition, the pipe coupling will preferably have an outer diameter of about 1 inch to about 2 inches. In accordance with an exemplary embodiment, the outer diameter and inner diameter of the pipe coupling can be manufactured in most any diameter from about ½ inch to about 8 inches.

Although, the use of the pipe coupling has been described for use with sprinkler systems including the repair thereof, the use of the pipe coupling described herein is not limited to sprinkler systems. The pipe coupling and method of use can be used with any water system, electrical system or any new installation of any type of pipe wherein two pipe ends are coupled.

In addition, the pipe couplings will preferably be molded plastic, however, it may be appreciated that the pipe couplings can be machined or manufactured by other known methods.

For example, in accordance with an exemplary embodiment, when redesigning with existing piping or constructing a new water project for gardens or other water features where valves and other equipment are involved and hard to reach, the pipe coupling 10 as disclosed herein can avoid in most cases replacing equipment and save time and money for the installer. In addition, the pipe coupling 10 can connect pipe the same way as the standard industry coupling. However, the standard industry coupling cannot connect pipe or repair pipe using one unit like the disclosed pipe coupling 10, which can save money and time for the consumer.

While the disclosure has been described in detail with reference to the exemplary embodiments thereof, it will be apparent to one skilled in the art that various changes and modifications can be made and equivalents employed, without departing from the present disclosure.

What is claimed is:

1. A pipe coupling comprising:
an elongated housing comprising a first end and a second end, the housing defining an elongated bore therein;
a stop located on an inner diameter of the housing, the stop located between the first end and the second ends of the housing, wherein a distance from the stop to one of the first and second ends is at least two times a distance from the stop to the other of the first and second end of the housing;
a first cylindrical bore extending from the first end to the stop;
a second cylindrical bore extending from the second end to the stop, wherein a length of the first cylindrical bore is greater than the second cylindrical bore; and
at least one marking on an outer surface of the housing adjacent to the first end of the elongated housing, the at least one marking extending towards the second end for a predetermined length.

2. The pipe coupling according to claim 1, comprising:
a third cylindrical bore which is at an approximate 90 degree angle to the first cylindrical and second cylindrical bores, and a third end on the third cylindrical bore.

3. The pipe coupling according to claim 1, wherein the pipe coupling is made of PVC.

4. The pipe coupling according to claim 1, comprising:
one or more breakaway or passable stops within the first cylindrical bore and/or the third cylindrical bore.

5. The pipe coupling according to claim 2, comprising:
one or more breakaway or passable stops within the first cylindrical bore and/or the third cylindrical bore.

6. The pipe coupling according to claim 1, wherein the pipe coupling is made of copper.

7. The pipe coupling according to claim 6, comprising:
a third cylindrical bore which is at an approximate 90 degree angle to the first cylindrical and second cylindrical bores, and a third end on the third cylindrical bore.

8. The pipe coupling according to claim 6, comprising:
one or more passable indentations within the first cylindrical bore.

9. The pipe coupling according to claim 6, comprising:
one or more passable stops within the first cylindrical bore and/or the third cylindrical bore.

10. The pipe coupling according to claim 7, comprising:
one or more passable stops within the first cylindrical bore and/or the third cylindrical bore.

11. The pipe coupling according to claim 1, wherein the markings are a series of ribs, which extend outward from the outer housing of the pipe coupling.

12. A method of installing a pipe coupling comprising:
selecting a pipe coupling comprising:
an elongated housing comprising a first end and a second end, the housing defining an elongated bore therein;
a stop located on an inner diameter of the housing, the stop located between the first end and the second ends of the housing, wherein a distance from the stop to one of the first and second ends is at least two times a distance from the stop to the other of the first and second end of the housing;
a first cylindrical bore extending from the first end to the stop;
a second cylindrical bore extending from the second end to the stop, wherein a length of the first cylindrical bore is greater than the second cylindrical bore; and
at least one marking on an outer surface of the housing adjacent to the first end of the elongated housing, the at least one marking extending towards the second end for a predetermined length;
inserting the first cylindrical bore of the pipe coupling onto a first pipe end;
advancing the pipe coupling in a first direction onto the first pipe end;
aligning the second cylindrical bore of the piping coupling with a second pipe end; and
advancing the pipe coupling in an opposite direction onto the second pipe end until the stop reaches the second pipe end.

13. The method of claim 12, comprising:
removing a section of pipe from a broken or damaged pipe and forming the first pipe end and the second pipe end.

14. The method of claim 12, comprising:
applying an adhesive to an inner diameter of the first cylindrical bore of the pipe coupling.

15. The method of claim 12, comprising:
applying an adhesive to an inner diameter of the second cylindrical bore of the pipe coupling.
